(19) United States
(12) Patent Application Publication
(10) Pub. No.: US 2025/0116844 A1
(43) Pub. Date: Apr. 10, 2025

(54) OPTICAL SYSTEM

(71) Applicant: TDK TAIWAN CORP., Taoyuan City (TW)

(72) Inventors: Wei-Jhe SHEN, Taoyuan City (TW); Sin-Jhong SONG, Taoyuan City (TW)

(21) Appl. No.: 18/906,946

(22) Filed: Oct. 4, 2024

Related U.S. Application Data
(60) Provisional application No. 63/588,441, filed on Oct. 6, 2023.

(51) Int. Cl. G02B 13/00; G02B 7/09; G02B 7/18; G02B 27/64

(52) U.S. Cl. CPC G02B 13/001; G02B 7/09; G02B 7/1805; G02B 27/64

(57) ABSTRACT

An optical system is provided, including a system base. The system base is connected to a first optical element. The system base includes a first connecting structure corresponding to the first optical element. The system base further includes a second connecting structure corresponding to a second optical element. The first optical element is not in contact with the second optical element.

### CROSS REFERENCE TO RELATED APPLICATIONS

This application claims the benefit of U.S. Provisional Application No. 63/588,441, filed Oct. 6, 2023, the entirety of which is/are incorporated by reference herein.

### BACKGROUND OF THE INVENTION

### Field of the Invention

The present disclosure relates to an optical system, and more particularly, the present disclosure relates to an optical system for an electronic device.

### Description of the Related Art

As the relevant technologies have been developed, many electronic devices (such as computers and tablets) are equipped with the capability to record images and videos. However, when an optical element (such as lens) having a long focal length is provided in an electronic device, the thickness of the electronic device may be increased, impeding the prospects for miniaturization of the electronic device. Therefore, how to design an optical system that may miniaturize the electronic device has become an important issue.

### BRIEF SUMMARY OF THE INVENTION

An embodiment of the present invention provides an optical system, including a system base. The system base is connected to a first optical element. The system base comprises a first connecting structure corresponding to the first optical element.

### BRIEF DESCRIPTION OF THE DRAWINGS

The present invention may be more fully understood by reading the subsequent detailed description and examples with references made to the accompanying drawings, wherein:

FIG. 1 is a schematic view of an electrical device according to some embodiment of the present disclosure;

FIG. 2 is a schematic view of an optical system, a first optical element, a second optical element, a third optical element, a first optical module optical element, a second optical module optical element and a third optical module optical element according to some embodiments of the present disclosure, in which the outer frame is represented by a dotted line;

FIG. 3 is an exploded view of the optical system, the first optical element, the second optical element, the third optical element, the first optical module optical element, the second optical module optical element, and the third optical module optical element according to some embodiments of the present disclosure;

FIG. 4 is a cross-sectional view along line A-A′ of FIG. 2 of the optical system, the first optical element, the second optical element, the third optical element, the first optical module optical element, a second optical module optical element and a third optical module optical element according to some embodiments of the present disclosure;

FIG. 5 is a cross-sectional view along line B-B′ of FIG. 2 of the optical system, the first optical element, the second optical element, the third optical element, the first optical module optical element, a second optical module optical element and a third optical module optical element according to some embodiments of the present disclosure;

FIG. 6 is a cross-sectional view along line C-C′ of FIG. 2 of the optical system, the first optical element, the second optical element, the third optical element, the first optical module optical element, a second optical module optical element and a third optical module optical element according to some embodiments of the present disclosure;

FIG. 7 is a cross-sectional view along line D-D′ of FIG. 2 of the optical system, the first optical element, the second optical element, the third optical element, the first optical module optical element, a second optical module optical element and a third optical module optical element according to some embodiments of the present disclosure.

### DETAILED DESCRIPTION OF THE INVENTION

The making and using of optical systems of embodiments of the present disclosure are discussed in detail below. It should be appreciated, however, that the embodiments provide many applicable inventive concepts that may be embodied in a wide variety of specific contexts. The specific embodiments discussed are merely illustrative of specific ways to make and use the embodiments and do not limit the scope of the disclosure.

It should be understood that, although the terms “first”, “second” etc. may be used herein to describe various elements, layers and/or portions, and these elements, layers, and/or portions should not be limited by these terms. These terms are only used to distinguish one element, layer, or portion. Thus, a first element, layer or portion discussed below could be termed a second element, layer or portion without departing from the teachings of some embodiments of the present disclosure. In addition, for the sake of brevity, terms such as “first” and “second” may not be used in the description to distinguish different elements. As long as it does not depart from the scope defined by the appended claims, the first element and/or the second element described in the appended claims can be interpreted as any element that meets the description in the specification.

It should be noted that the technical solutions provided by different embodiments below may be interchangeable, combined or mixed to form another embodiment without departing from the spirit of the present disclosure.

Unless defined otherwise, all technical and scientific terms used herein have the same meaning as commonly understood by one of ordinary skill in the art to which this disclosure belongs. It should be appreciated that each term, which is defined in a commonly used dictionary, should be interpreted as having a meaning conforming to the relative skills and the background or the context of the present disclosure, and should not be interpreted in an idealized or overly formal manner unless defined otherwise.

The scale of the drawings in the present disclosure may be drawn according to the actual size. The scale of the same figure in the present disclosure can be used as the actual manufacturing scale of the devices, equipment, elements, etc. of the present disclosure. It should be noted that each figure may be drawn at different orientations, which may result in different size ratios among different figures. However, the size ratio shown in an individual figure is not affect by the different size ratios between different figures. People with ordinary skill in the art can understand that the size ratio of the figures in the present disclosure can be used as a distinguishing feature from the prior art.

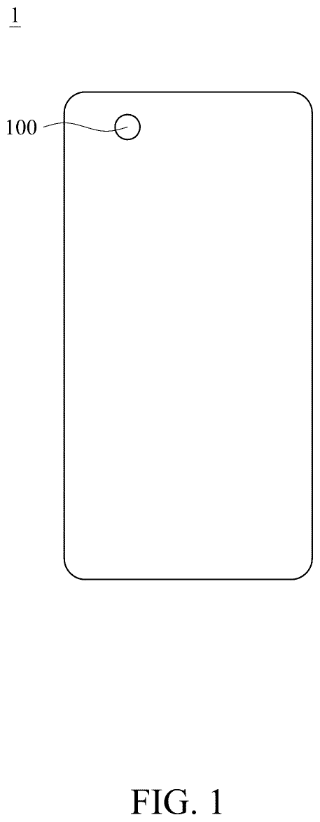

Firstly, please refer to FIG. 1, FIG. 1 is a schematic view of an electrical device 1 according to some embodiment of the present disclosure. As shown in FIG. 1, an optical system 100 of some embodiment of the present disclosure may be mounted in an electrical device 1 for taking photos or videos, wherein the aforementioned electrical device 1 may, for example, be a smartphone or a digital camera, but the present disclosure is not limited to these. It should be noted that the position and the size between the optical system 100 and the electrical device 1 shown in FIG. 1 are only an example, which is not for limiting the position and the size between the optical system 100 and the electrical device 1. In fact, according to different needs, the optical system 100 may be mounted at different positions in the electrical device 1.

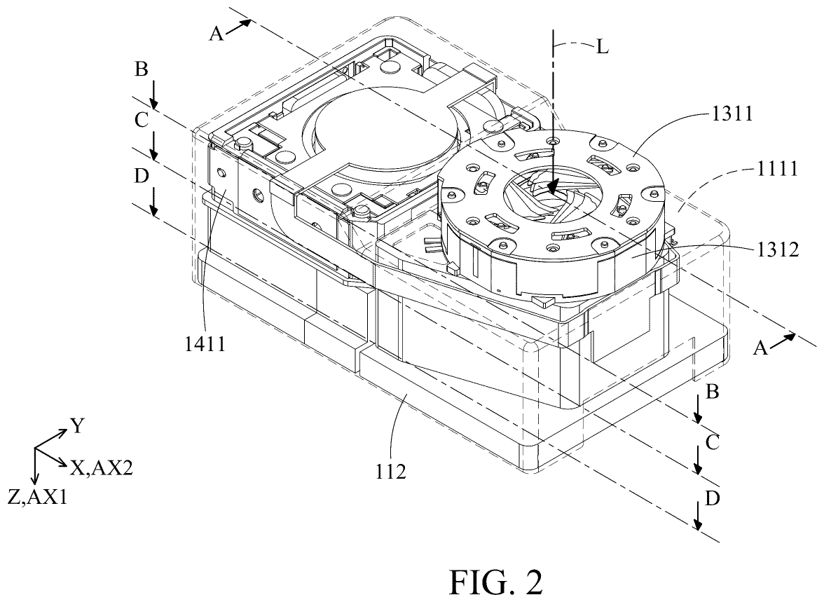

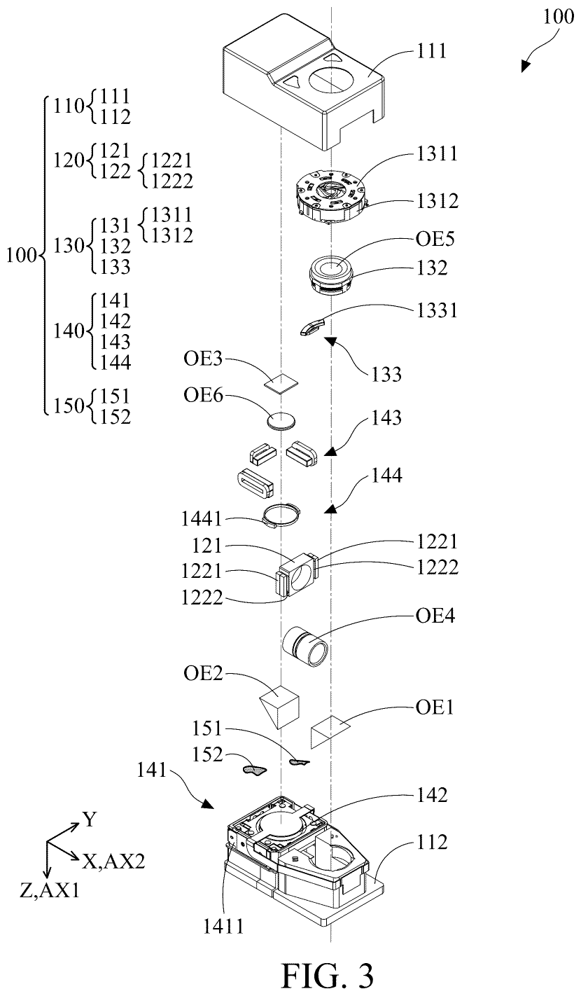

Please refer to FIG. 2 and FIG. 3. FIG. 2 is a schematic view of an optical system 100, a first optical element OE1, a second optical element OE2, a third optical element OE3, a first optical module optical element OE4, a second optical module optical element OE5 and a third optical module optical element OE6 according to some embodiments of the present disclosure, in which the outer frame 111 is represented by a dotted line. FIG. 3 is an exploded view of the optical system 100, the first optical element OE1, the second optical element OE2, the third optical element OE3, the first optical module optical element OE4, the second optical module optical element OE5, and the third optical module optical element OE6 according to some embodiments of the present disclosure.

The optical system 100 may include a system fixed part 110, a first optical module 120, a second optical module 130, a third optical module 140, and a connecting assembly 150.

The system fixed part 110 may include a system housing 111 and a system base 112. The system housing 111 is disposed on the system base 112, and the system housing 111 and the system base 112 may be connected to each other to form an internal space to accommodate other elements of the optical system 100 or the first optical element OE1 and the second optical element OE2, the third optical element OE3, the first optical module optical element OE4, the second optical module optical element OE5, and the third optical module optical element OE6.

The first optical module 120 may be disposed on the system base 112, and the first optical module 120 may include a first optical module movable part 121 and a first optical module driving assembly 122. The first optical module movable part 121 may be connected to and carry the first optical module optical element OE4, and the first optical module driving assembly 122 may drive the first optical module movable part 121 to move along a second axis AX2 that is perpendicular to the first axis AX1 relative to the system base 112, so that the first optical module optical element OE4 may move along the second axis AX2 relative to the system base 112.

The second optical module 130 may be disposed on a system housing first top surface 111A of the system housing 111, and the second optical module 130 may include a second optical module fixed part 131, a second optical module movable part 132 and a second optical module driving assembly 133.

The second optical module fixed part 131 may include a second optical module housing 1311 and a second optical module base 1312. The second optical module movable part 132 may be disposed between the second optical module housing 1311 and the second optical module base 1312, and the second optical module movable part 132 may be connected to and carry the second optical module optical element OE5.

The second optical module driving assembly 133 may drive the second optical module movable part 132 to rotate around the first axis AX1 so that the blades (not shown) inside the second optical module fixed part 131 may be opened or closed, thereby controlling the amount of light incident to the second optical module optical element OE5.

The third optical module 140 may be disposed on the system base 112, and the third optical module 140 may be located in an accommodating space formed by the system housing 111 and the system base 112. In detail, the third optical module 140 may be disposed on a system base first surface 112A and a system base second surface 112B of the system base 112. However, it should be noted that the second optical module 130 is not located in the first accommodating space.

The system base first surface 112A and the system base second surface 112B may face the third optical module 140. For example, the system base first surface 112A and the system base second surface 112B may face the same direction, and the system base first surface 112A and the system base second surface 112B may be perpendicular to the first axis AX1.

The third optical module 140 may include a third optical module fixed part 141, a third optical module movable part 142, a third optical module first driving assembly 143, and a third optical module second driving assembly 144.

The third optical module fixed part 141 may include a third optical module base 1411. The third optical module movable part 142 may be disposed between the system housing 111 and the third optical module base 1411, and the third optical module movable part 142 may be connected to and carry the third optical element OE3. The third optical module first driving assembly 143 may drive the third optical module movable part 142 to move relative to the third optical module base 1411 along a direction that is perpendicular to the first axis AX1, so that the third optical element OE3 may move along the direction that is perpendicular to the first axis AX1 relative to the third optical module base 1411. At the same time, the third optical module first driving assembly 143 may drive the third optical module movable part 142 to move along the X-axis and the Y-axis, so that the third optical element OE3 may move relative to the third optical module base 1411 along the directions of the X-axis and the Y-axis, thereby the third optical element OE3 may achieve the effects of Auto Focus (AF) and Optical Image Stabilization (OIS). The third optical module second driving assembly 144 drives the third optical module optical element OE6 to move relative to the third optical module base 1411 in a direction perpendicular to the first axis AX1.

The connecting assembly 150 may include a first connecting element 151 and a second connecting element 152. The first connecting element 151 and the second connecting element 152 may have adhesive properties. For example, the first connecting element 151 and the second connecting element 152 may be made of glue, solder or other materials.

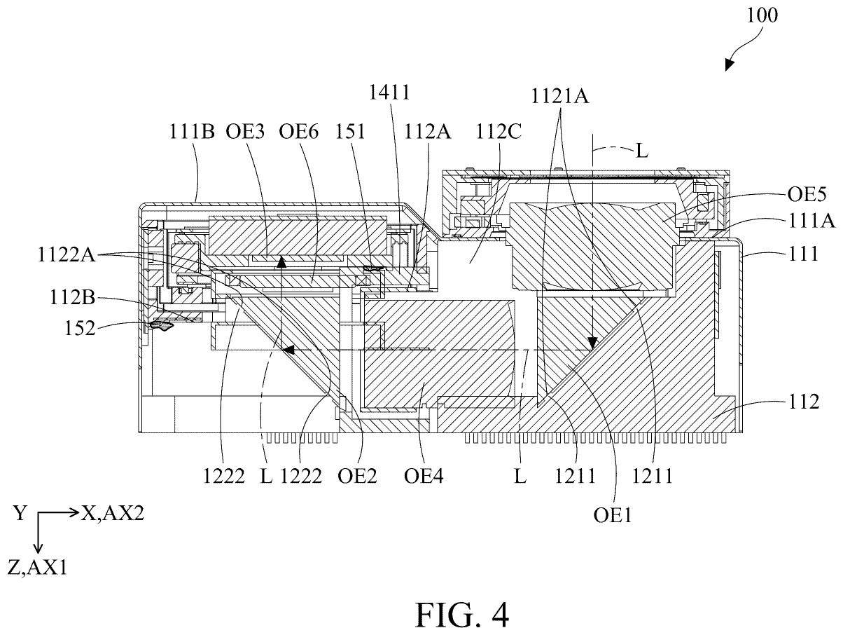

Please refer to FIG. 4. FIG. 4 is a cross-sectional view along line A-A′ of FIG. 2 of the optical system 100, the first optical element OE1, the second optical element OE2, the third optical element OE3, the first optical module optical element OE4, a second optical module optical element OE5 and a third optical module optical element OE6 according to some embodiments of the present disclosure.

As shown in FIG. 4, the first optical element OE1 is connected to the system base 112, and the second optical element OE2 is also connected to the system base 112. Furthermore, the system base 112 may include a first connecting structure 1121 and a second connecting structure 1122.

The first connecting structure 1121 may correspond to the first optical element OE1. For example, the first connecting structure 1121 may protrude from the system base 112 toward the first optical element OE1. The first connecting structure 1121 may support the first optical element OE1 such that there is a gap between the first optical element OE1 and the system base 112.

The second connecting structure 1122 may correspond to the second optical element OE2. For example, the second connecting structure 1122 may protrude from the system base 112 toward the second optical element OE2. The second connecting structure 1122 may support the second optical element OE2 so that there is a gap between the second optical element OE2 and the system base 112.

According to some embodiments of the present disclosure, the gap between the first optical element OE1 and the system base 112 and the gap between the second optical element OE2 and the system base 112 may contain air but not other substances to avoid affecting the optical properties of optical system 100.

According to some embodiments of the present disclosure, the gap between the first optical element OE1 and the system base 112 and the gap between the second optical element OE2 and the system base 112 may contain materials that improve optical properties. The first connecting structure 1121 may include a first connecting surface 1121A, and the second connecting structure 1122 may include a second connecting surface 1122A. The first connecting surface 1121A may face and be in contact with the first optical element OE1, but the direction in which the first connecting surface 1121A faces may not be perpendicular or parallel to the system base first surface 112A and the system base second surface 112B.

In other words, the direction that the first connecting surface 1121A faces may not be perpendicular to and not parallel to the first axis AX1. The second connecting surface 1122A may face and be in contact with the second optical element OE2, but the direction in which the second connecting surface 1122A faces may not be perpendicular or parallel to the system base first surface 112A and the system base second surface 112B. In other words, the direction that the second connecting surface 1122A faces may not be perpendicular to and not parallel to the first axis AX1.

As shown in FIG. 4, the second optical module 130 and the first optical element OE1 may be arranged along the first axis AX1. The first optical element OE1, the first optical module 120, and the second optical element OE2 may be arranged along the second axis AX2. The second optical element OE2 and the third optical module 140 may be arranged along the first axis AX1.

Alternatively, in other words, when viewed along the first axis AX1, the second optical module 130 and the first optical element OE1 may at least partially overlap. When viewed along the second axis AX2, the first optical element OE1 and the first optical module 120 may at least partially overlap. When viewed along the second axis AX2, the first optical element OE1 and the second optical element OE2 may at least partially overlap.

Moreover, when viewed along the second axis AX2, the first optical module 120 and the second optical element OE2 may at least partially overlap. When viewed along the second axis AX2, the first optical element OE1, the first optical module 120 and the second optical element OE2 may at least partially overlap. When viewed along the first axis AX1, the second optical element OE2 and the third optical module 140 may at least partially overlap.

Please continue to refer to FIG. 4. The second optical module optical element OE5 and the first optical element OE1 are arranged along the first axis AX1. The first optical element OE1, the first optical module optical element OE4, and the second optical element OE2 are arranged along the second axis AX2. The second optical element OE2, the third optical module optical element OE6 and the third optical element OE3 are arranged along the first axis AX1.

Moreover, the first optical module optical element OE4 is disposed between the first optical element OE1 and the second optical element OE2, so that the first optical element OE1 is not in contact with the second optical element OE2.

Since the first optical module 120 has a larger moving distance, the first optical module 120 may effectively increase the focusing distance of the optical system 100.

Since the second optical module 130 is far away from the third optical module 140, the second optical module 130 may accurately focus the optical system 100.

Since the third optical module 140 is disposed on the opposite side of the first optical module 120, the optical system 100 may effectively utilize the space and may focus more accurately.

There may be a gap between the first optical module optical element OE4 and the first optical element OE1, and there may be a gap between the first optical module optical element OE4 and the second optical element OE2. In this way, the optical element OE4 of the first optical module may move along the second axis AX2.

According to some embodiments of the present disclosure, the gap between the first optical module optical element OE4 and the first optical element OE1 and the gap between the first optical module optical element OE4 and the second optical element OE2 may contain air but not other substances to avoid affecting the optical properties of the optical system 100.

According to some embodiments of the present disclosure, the gap between the first optical module optical element OE4 and the first optical element OE1 and the gap between the first optical module optical element OE4 and the second optical element OE2 may contain materials that improve optical properties.

As shown in FIG. 4, a light L may be incident on the second optical module 130 from outside the optical system 100. The second optical module 130 may transmit the light L to the first optical element OE1. The first optical element OE1 may transmit the light L to the first optical module 120. The first optical module 120 may transmit the light L to the second optical element OE2. The second optical element OE2 may transmit the light L to the third optical module 140.

In detail, the light L may be incident on the second optical module optical element OE5 from outside the optical system 100 along the first axis AX1. The second optical module optical element OE5 may transmit the light L along the first axis AX1 to the first optical element OE1. The first optical element OE1 may refract and/or reflect the light L from the first axis AX1 to along the second axis AX2, and the first optical element OE1 may transmit the light L along the second axis AX2 to the first optical module optical element OE4.

Then, the first optical module optical element OE4 may transmit the light L along the second axis AX2 to the second optical element OE2. The second optical element OE2 may refract and/or reflect the light L from the second axis AX2 to the first axis AX1, and the second optical element OE2 may transmit the light L along the first axis AX1 to the third optical module optical element OE6. The third optical module optical element OE6 may transmit the light L along the first axis AX1 to the third optical element OE3.

Please continue to refer to FIG. 4. There may be a gap between the third optical module base 1411 and the first optical element OE1, and there may be a gap between the third optical module base 1411 and the first optical module optical element OE4.

According to some embodiments of the present disclosure, the gap between the third optical module base 1411 and the first optical element OE1, and the gap between the third optical module base 1411 and the first optical module optical element OE4 may contain air but not other substances to avoid affecting the optical properties of the optical system 100.

According to some embodiments of the present disclosure, the gap between the third optical module base 1411 and the first optical element OE1, and the gap between the third optical module base 1411 and the first optical module optical element OE4 may contain materials that improve optical properties.

Please continue to refer to FIG. 4. The first connecting element 151 may be in direct contact with the system base first surface 112A and the third optical module 140 to fix the third optical module 140 on the system base first surface 112A. The second connecting element 152 may be in direct contact with the system base second surface 112B and the third optical module 140 to fix the third optical module 140 on the system base second surface 112B. In this way, an effective and strong connection may be formed.

Moreover, according to some embodiments of the present disclosure (not shown in the figures), the first connecting element 151 may be in direct contact with the second connecting element 152. In this way, the connection effect may be enhanced, thereby strengthening the structure of the optical system 100.

According to some embodiments of the present disclosure, the system base second surface 112B may be “lower” than the system base first surface 112A. For example, compared to the system base first surface 112A, the system base second surface 112B is further away from a system housing second top surface 111B of the system housing 111.

Please continue to refer to FIG. 4. When viewed along the first axis AX1, the system housing first top surface 111A and the system housing second top surface 111B may not overlap. When viewed along the first axis AX1, the system housing first top surface 111A and the system base first surface 112A may not overlap. When viewed along the first axis AX1, the system housing first top surface 111A and the system base second surface 112B may not overlap.

When viewed along the first axis AX1, the system housing second top surface 111B and the system base first surface 112A may at least partially overlap. When viewed along the first axis AX1, the system housing second top surface 111B and the system base second surface 112B may at least partially overlap. When viewed along the first axis AX1, the system base first surface 112A and the system base second surface 112B may not overlap.

In this way, the structure of the optical system 100 may be more stable, the space may be effectively used, and the effect of miniaturization may be achieved.

Please continue to refer to FIG. 4. When viewed along the second axis AX2, the system housing first top surface 111A and the system housing second top surface 111B may not overlap. When viewed along the second axis AX2, the system housing first top surface 111A and the system base first surface 112A may not overlap. When viewed along the second axis AX2, the system housing first top surface 111A and the system base second surface 112B may not overlap.

When viewed along the second axis AX2, the system housing second top surface 111B and the system base first surface 112A may not overlap. When viewed along the second axis AX2, the system housing second top surface 111B and the system base second surface 112B may not overlap. When viewed along the second axis AX2, the system base first surface 112A and the system base second surface 112B may not overlap.

In this way, the structure of the optical system 100 may be more stable, the space may be effectively used, and the effect of miniaturization may be achieved.

Please continue to refer to FIG. 4. When viewed along the second axis AX2, the system housing first top surface 111A may be located between the system housing second top surface 111B and the system base second surface 112B of the. When viewed along the second axis AX2, the system housing first top surface 111A may be located between the system housing second top surface 111B and the system base first surface 112A.

When viewed along the second axis AX2, the system base first surface 112A may be located between the system housing second top surface 111B and the system base second surface 112B. When viewed along the second axis AX2, the system base first surface 112A may be located between the system case first top surface 111A and the system base second surface 112B.

In this way, the structure of the optical system 100 may be more stable, the space may be effectively used, and the effect of miniaturization may be achieved.

Please continue to refer to FIG. 4. When viewed along the first axis AX1, the system base first surface 112A and the first optical module 120 may at least partially overlap. When viewed along the second axis AX2, the system base second surface 112B and the first optical element OE1 may at least partially overlap.

In this way, the structure of the optical system 100 may be more stable, the space may be effectively used, and the effect of miniaturization may be achieved.

Please continue to refer to FIG. 4. The system housing first top surface 111A, the system housing second top surface 111B, the system base first surface 112A, and the system base second surface 112B may face the same direction. For example, the system housing first top surface 111A, the system housing second top surface 111B, the system base first surface 112A, and the system base second surface 112B may be perpendicular to the first axis AX1. In this way, the structure of the optical system 100 may be more stable, the space may be effectively used, and the effect of miniaturization may be achieved.

As shown in FIG. 4, when viewed along the second axis AX2, the third optical module 140 and the first optical element OE1 may at least partially overlap.

In this way, the structure of the optical system 100 may be more stable, the space may be effectively used, and the effect of miniaturization may be achieved.

Please continue to refer to FIG. 4. The system base 112 may further include a system base abutment portion 112C. The system base abutment portion 112C may abut the first optical element OE1, the first optical module 120, and the second optical module 130. In this way, the structure of the optical system 100 may be more stable.

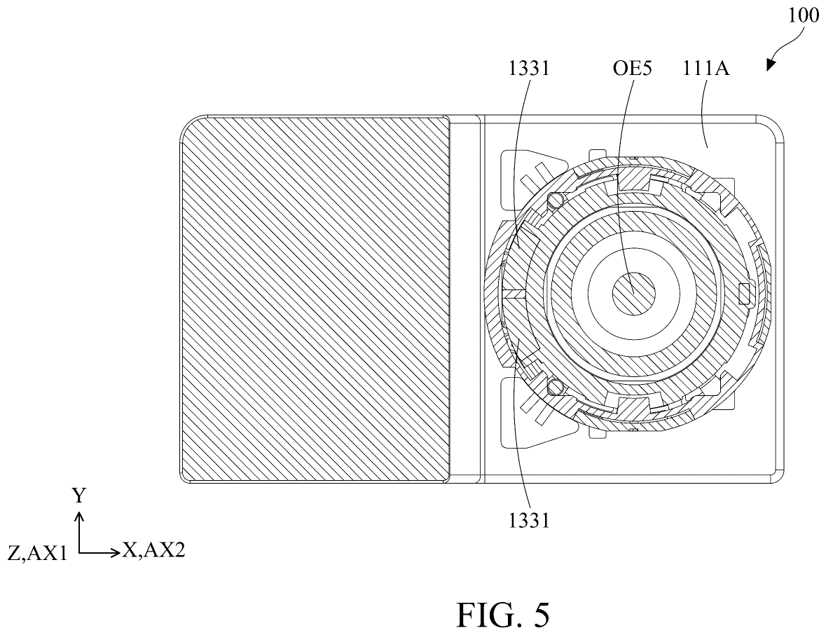

Please refer to FIG. 5. FIG. 5 is a cross-sectional view along line B-B′ of FIG. 2 of the optical system 100, the first optical element OE1, the second optical element OE2, the third optical element OE3, the first optical module optical element OE4, a second optical module optical element OE5 and a third optical module optical element OE6 according to some embodiments of the present disclosure.

As shown in FIG. 5, the second optical module driving assembly 133 may include a second optical module driving magnet 1331. When viewed along the first axis AX1, the second optical module driving magnet 1331 may have an arc shape.

In this way, the internal space of the optical system 100 may be effectively used, thereby achieving the effect of miniaturization.

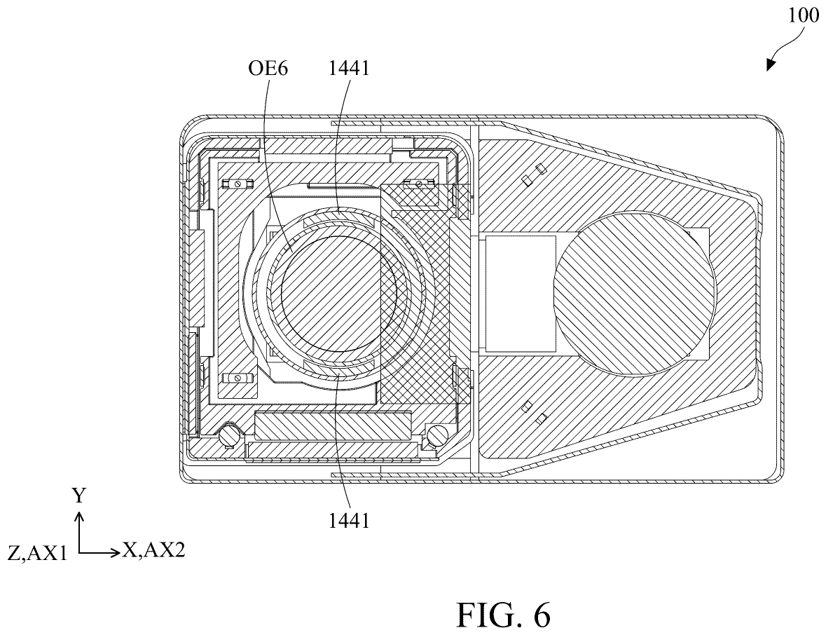

Please refer to FIG. 6. FIG. 6 is a cross-sectional view along line C-C′ of FIG. 2 of the optical system 100, the first optical element OE1, the second optical element OE2, the third optical element OE3, the first optical module optical element OE4, a second optical module optical element OE5 and a third optical module optical element OE6 according to some embodiments of the present disclosure.

As shown in FIG. 6, the third optical module second driving assembly 144 may include a third optical module second driving magnet 1441. When viewed along the first axis AX1, the second driving magnet 1441 of the third optical module may have an arc shape.

In this way, the internal space of the optical system 100 may be effectively used, thereby achieving the effect of miniaturization.

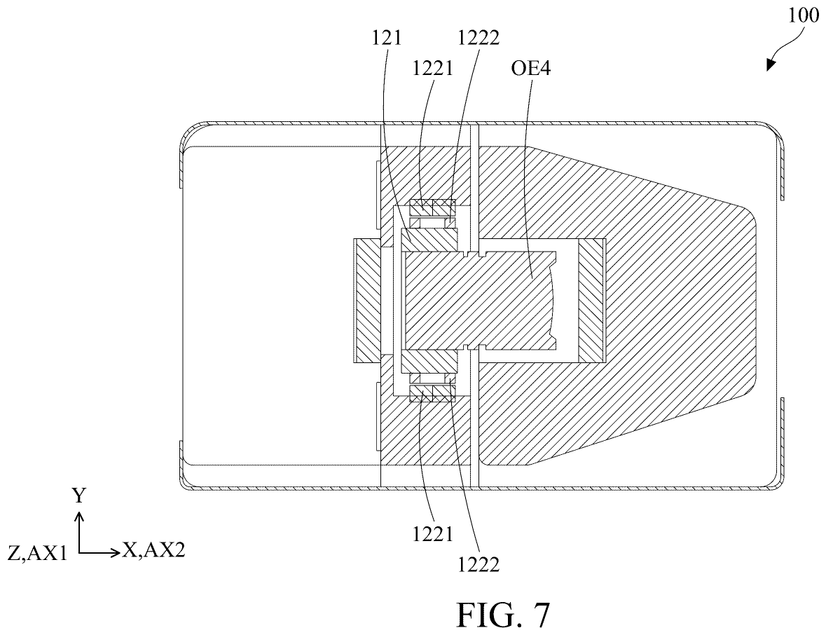

Please refer to FIG. 7. FIG. 7 is a cross-sectional view along line D-D′ of FIG. 2 of the optical system 100, the first optical element OE1, the second optical element OE2, the third optical element OE3, the first optical module optical element OE4, a second optical module optical element OE5 and a third optical module optical element OE6 according to some embodiments of the present disclosure.

As shown in FIG. 7, the first optical module driving assembly 122 may include a first optical module driving magnet 1221 and a first optical module driving coil 1222.

According to some embodiments of the present disclosure, the first optical module driving magnet 1221 may be disposed on the first optical module movable part 121, and the first optical module driving coil 1222 may be disposed on the system base 112 to drive the first optical module. The group movable part 121 moves relative to the system base 112 along the second axis AX2.

In general, the arrangement of the optical modules of the optical system 100 of the present disclosure may effectively improve the accuracy of focusing and increase the focusing distance. Moreover, the system base 112 of the optical system 100 of the present disclosure may effectively improve the stability of the optical system 100, enhance the structure of the optical system 100, and achieve miniaturization.

Although embodiments of the present disclosure and their advantages have been described in detail, it should be understood that various changes, substitutions and alterations may be made herein without departing from the spirit and scope of the disclosure as defined by the appended claims. For example, it will be readily understood by those skilled in the art that many of the features, functions, processes, and materials described herein may be varied while remaining within the scope of the present disclosure. Moreover, the scope of the present application is not intended to be limited to the particular embodiments of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps. In addition, the scope of the present disclosure is defined by the scope of the appended claims. In addition, each scope of the claims is constructed as a separate embodiment, and various combinations of the claims and combinations of embodiments are within the scope of the present disclosure.

What is claimed is:

1. An optical system, comprising:
a system base, connected to a first optical element,
wherein the system base comprises a first connecting structure corresponding to the first optical element.

2. The optical system as claimed in claim 1,
wherein the system base further comprises a second connecting structure corresponding to a second optical element,
wherein the first optical element is not in contact with the second optical element.

3. The optical system as claimed in claim 2,
wherein the system base is connected to a first optical module, and the first optical module carries a first optical module optical element,
wherein the first optical module optical element is disposed between the first optical element and the second optical element,
wherein there is a gap between the first optical module optical element and the first optical element,
wherein there is a gap between the first optical module optical element and the second optical element.

4. The optical system as claimed in claim 3, further comprising:
a system housing, comprising a system housing first top surface,
wherein a second optical module is disposed on the system housing first top surface,
wherein the first optical element and the second optical module are arranged along a first axis.

5. The optical system as claimed in claim 4,
wherein the first optical module optical element moves along a second axis that is perpendicular to the first axis.

6. The optical system as claimed in claim 4,
wherein the system base comprises a system base abutment portion, and the system base abutment portion abuts the first optical element, the first optical module, and the second optical module.

7. The optical system as claimed in claim 4,
wherein the second optical module receives a light and transmits the light to the first optical element,
wherein the first optical element transmits the light to the first optical module optical element,
wherein the first optical module optical element transmits the light to the second optical element,
wherein the second optical element transmits the light to a third optical module,
wherein the second optical element and the third optical module are arranged along the first axis.

8. The optical system as claimed in claim 4,
wherein the second optical module further comprises:
a second optical module movable part, connected to a second optical module optical element;
a second optical module base, wherein the second optical module movable part is movable relative to the second optical module base; and
a second optical module driving assembly, driving the second optical module movable part to move around the first axis.

9. The optical system as claimed in claim 8,
wherein the second optical module driving assembly comprises a second optical module driving magnet,
wherein when viewed along the first axis, the second optical module driving magnet has an arc shape.

10. The optical system as claimed in claim 4,
wherein the system base further comprises:
a system base first surface, facing a third optical module; and
a system base second surface, facing the third optical module,
wherein the system base first surface and the system base second surface face the same direction,
wherein the system base first surface and the system base second surface face are perpendicular to the first axis,
wherein when viewed along a second axis that is perpendicular to the first axis, the system base first surface does not overlap the system base second surface.

11. The optical system as claimed in claim 10, further comprising:
a first connecting element, in direct contact with the system base first surface and the third optical module; and
a second connecting element, in direct contact with the system base second surface and the third optical module,
wherein the first connecting element is in direct contact with the second connecting element.

12. The optical system as claimed in claim 10,
wherein when viewed along the first axis, the system base first surface at least partially overlaps the first optical module,
wherein when viewed along the second axis, the system base second surface at least partially overlaps the first optical element.

13. The optical system as claimed in claim 10,
wherein a first connecting surface of the first connecting structure faces the first optical element,
wherein the first connecting structure supports the first optical element,
wherein the first connecting surface faces is not perpendicular or parallel to the system base first surface.

14. The optical system as claimed in claim 10,
wherein the system housing first top surface and the system base first surface face the same direction.

15. The optical system as claimed in claim 10,
wherein when viewed along the second axis, the system housing first top surface does not overlap with the system base first surface,
wherein when viewed along the second axis, the system housing first top surface does not overlap with the system base second surface,
wherein when viewed along the second axis, the system base first surface is located between the system housing first top surface and the system base second surface.

16. The optical system as claimed in claim 10,
wherein the third optical module is located in an accommodating space formed by the system base and the system housing.

17. The optical system as claimed in claim 16,
wherein the second optical module is not located in the accommodation space.

18. The optical system as claimed in claim 10,
wherein the third optical module further comprises:
a third optical module movable part, connected to a third optical element;
a third optical module base, wherein the third optical module movable part is movable relative to the third optical module base;
a third optical module first driving assembly, drives the third optical module movable part to move in a direction that is perpendicular to the first axis; and
a third optical module second driving assembly, drives the third optical module optical element, to move in a direction that is perpendicular to the first axis,
wherein when viewed along the second axis, the third optical module at least partially overlaps the first optical element.

19. The optical system as claimed in claim 18,
wherein there is a gap between the third optical module base and the first optical element.

20. The optical system as claimed in claim 18,
wherein there is a gap between the third optical module base and the first optical module optical element.
